(19) United States
(12) Patent Application Publication
(10) Pub. No.: US 2009/0198636 A1
(43) Pub. Date: Aug. 6, 2009

(54) Method and apparatus for a responsive learning program

(76) Inventors: Kathryn Jackson, Ocean City, NJ (US); Thomas Tucker, Ocean City, NJ (US)

Correspondence Address: Bressler, Amery & Ross, P.C., 17 State Street, New York, NY, 10004, US

(21) Appl. No.: 12/012,874

(22) Filed: Feb. 6, 2008

(51) Int. Cl. G06N 5/00

(52) U.S. Cl. 706/45

(57) ABSTRACT

A method for a responsive learning program in which a skills and knowledge base of an employee to successfully perform at his/her employment are utilized to determine various criteria of steps by which to manage, and improve the quality and efficiency of the employee's skill set and knowledge is presented. Utilizing commonalities of the skill and knowledge set and reusable components of the criteria steps throughout the methodology allows for linkages as between the criteria steps to be identified and utilized. Course programs containing varying modules, each having an independent number of lessons therein, are based upon the skill and knowledge set and the criteria steps, can be created for any business. Identification of the common elements and linkages between the employee skill sets and employment criteria allows for creation of a responsive learning program to be implemented in any business.

### FIELD OF THE INVENTION

The present invention relates generally to a method and apparatus to improve the quality and efficiency of an organization's personnel's skill sets and knowledge, and more particularly, to a method and apparatus of identifying common elements and linkages between an organization's processes to allow for successful organizational relationships, personnel training and operations.

### BACKGROUND OF THE INVENTION

At one level of understanding, an organization can be defined as a social arrangement between people which pursues a collective goal(s) and which controls its own performance. Indeed, the science of sociology understands “organization” as planned, coordinated and purposeful action of human beings to construct or compile a common tangible or intangible product. By such coordinated and planned cooperation of the people in the organization, the organization as a whole is able to solve tasks that lie beyond the abilities of any of the individuals. In order to have a successful organization, however, emphasis needs to be put on areas such as individual/group processes, functionality, and overall structures of institutions.

Translating that emphasis to practical reality is easier said than done. Often times there are disconnects at different points within the individual/group processes, the functionality of the company, and/or within the structure of the institution. The disconnects within the functionality of the organization often deal with having improper tools with which to manufacture specific products. Disconnects within the overall structure of the institution often have to do with improper management organization or responsibility. Disconnects within the individual/group processes often have to do with improper job task identification and improper training. These types of disconnects are often times the most difficult to identify.

Failures of the organization, whether manifested because of the disconnects or other reasons, can lead to poor business results. These poor business results manifest themselves in lower profitability, higher customer complaints, and, if a public company, shareholder dissatisfaction. Many companies which are unable to recover from poor business practices find the need for cutbacks, layoffs, sale of business units, or even bankruptcy filing.

For many organizations the front line to stave off failure, and one industry in which job/task identification and training is critical, is the customer relations call center. As the call center is a direct contact with their customer base, many corporate leaders have become obsessed with investing in and building up of call centers to build and maintain relationships with their customers. Every day, millions of customer relationships are either strengthened or injured because of the interaction a customer has with the company's call center. Corporate leaders, recognizing the value of keeping loyal and profitable customers, understand that each interaction a customer has with a call center is a window of opportunity with which to shape the organization's image in the eyes of the customer. Organizations must nurture this critical customer-call center link to remain competitive. However, high turnover rates and overworked supervisors are a reality of the call center industry. Because call centers are grappling with astronomical employee turnover, an inordinate amount of time and money must be spent on locating, hiring, training, and upgrading skill sets of call center employees. Customer feedback on the call centers indicates that quality monitoring and agent skills training are lacking in the industry.

Thus it can be seen that there is a need for improvement of the quality and efficiency of an organization's personnel's skills set and knowledge.

### SUMMARY OF THE INVENTION

Accordingly, the present invention is directed to allow for an ongoing process that assesses the business and/or the industries in which the company is involved, assesses the processes needed to function in such business/industry, sets goals and strategies to conform to such process functionality, and then reassesses each goal/strategy on a regular basis to determine how it has been implemented and whether it has succeeded or needs replacement by a new goal/strategy.

To implement such, the present invention comprises a series of computer-based training programs having of a series of courses that combine quality content with time compressed learning. In one embodiment the training programs are broken down as four modules relating to a quality monitoring foundation and fifty-four modules relating to agent skills training.

The quality monitoring foundation modules include training contact center professionals to develop a quality monitoring assessment form that includes suggested best practice behavioral components, a definitions list (“nuance” list) that includes suggested best practice definitions, and a comprehensive calibration session that ensures call center employee raters (i.e., persons doing the assessment) consistently rate performance for each agent (i.e., across the agent group).

The agent skills training modules include training related to call handling, such as: greeting, assessing, solving, closing, speaking, courtesy, listening and empathy, contact control, and customer disposition. Each module in the agent skills training modules has a pretest, practice lesson and post test component.

Thus, upon identification of a gap in the skill/knowledge set of the employee, the manager has access to a computer based lesson directly aligned to addressing that gap. The direct alignment between the specific lessons and the gap in the customer call agent's skill and/or knowledge base is accomplished by recognition of linkages.

In addition to the two sets of modules, additional products include a quality monitoring program development, coach training, performance management infrastructure development (e.g., measurement, standards, reward and recognition), and operations management (e.g., work force optimization linkages, service level management, strategy).

To support the modules, the training there under, and the additional products, Webinars are conducted. The Webinars provide direct access to the experts for a community of users.

The present invention, including its features and advantages, will become more apparent from the following detailed description with reference to the accompanying drawings.

### BRIEF DESCRIPTION OF THE DRAWINGS

FIG. 1 illustrates a flow chart of a methodology for implementation of the responsive learning program, according to an embodiment of the present invention.

FIG. 2 illustrates a chart of the quality monitoring foundation course content, according to an embodiment of the present invention.

FIGS. 3(a) through 3(h) illustrate charts of the agent skills learning course content, according to an embodiment of the present invention.

FIG. 4 illustrates a chart of the seven component pieces to a successful responsive learning program, according to an embodiment of the present invention.

### DETAILED DESCRIPTION

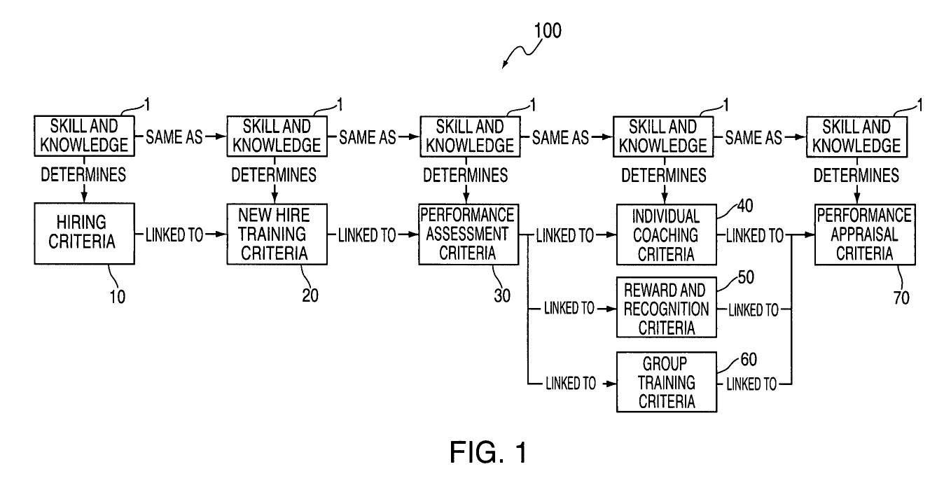

FIGS. 1-4 illustrate a method for a responsive learning program in which linkages between the skills and knowledge required by a company employee to be an expert in their job and as between the functional processes that contribute to the successful functioning of a corporation is shown.

Referring now specifically to FIG. 1, the skill and knowledge base 1 required by the employee to be an expert in their job is shown. The skill and knowledge base comprises a set of skills and knowledge allowing for competent completion of a job. In the example shown in the figure, the skill and knowledge base 1 is the same throughout the methodology for the implementation of the responsive learning program. That is, the skills and knowledge required by the employee to successfully carry out the job are the base upon which each of the other steps across the entire process are built (i.e., the skills and knowledge allow for the determination and/or identification of the criteria of the steps across the entire process).

For instance, a successful employee in a call center must have a skill set conforming to a particular rate of speech. That is, it is important for a call center employee who is responsible for the communication(s) with the customers to have a particular and easily understandable rate of speech. This rate of speech skill is definable and thus can be one of the skills and knowledge set upon which the steps of the methodology can be built.

Accordingly, the first step in the responsive learning program methodology 100 the recruiting and hiring criteria 10 are determined/identified. The criteria for recruiting and hiring act to identify what type of person the company needs for the position to be filled and the skills that the person needs to properly complete the job. Each of these individually are components of the criteria. It is to be understood, of course, that there can be and/or are additional components.

For instance, utilizing the call center example, the skill relating to a particular rate of speech is an observable skill when a potential employee is interviewed and can become a behavioral interview question (e.g., “describe to me a time when you had to change the rate of your speech in order to be more effective in your communication?”). Thus the recruiting and hiring criteria are determined by the skills and knowledge that the employee has to have in order to successfully complete the job.

The second step in the responsive learning program methodology 100 is determining/identifying the new hire training criteria 20. The new hire initial training criteria can be broken down into components and are implemented to teach the newly hired employee about the company's products, services and to reinforce the skills that the employee was hired for. The new hire training criteria 20 is based upon, firstly, the skill and knowledge base 1 and, secondly, the reusable components of the previous step of hiring criteria 10. That is, new hire criteria 20 is determined based on the skill and knowledge base 1 and by linking through relevant components of the hiring criteria 10.

For instance, utilizing again the example of the call center wherein the employee must have a skill set conforming to a particular rate of speech and the hiring criteria as identified by that particular rate of speech, the second step of the methodology is determined by and linked to each. How to communicate, that is, the rate of speech thus becomes a new hire training lesson and part of the company's standard curriculum.

The third step in the responsive learning program methodology 100 is determining/identifying of the performance assessment criteria 30. Components of such criteria relate to how to monitor for the skills and knowledge upon which the new hire training was conducted and are included on a quality monitoring form. It is to be understood, of course, that there can be and/or are additional components. Additionally a definition of the expectation level is included as an addendum to the form so each rater is assessing the employee the same way. That is, upon establishment and completion of standards for the performance assessment it can be determined whether the employee may be struggling or failing in any of the skills and knowledge base required.

For instance, utilizing again the call center example, the performance of the employee on the phone with the customers can be assessed allowing for a determination of whether the employee is excelling or having difficulty with the communication/rate of speech skill.

The fourth, fifth and sixth steps in the responsive learning program methodology 100 are determining/identifying the individual coaching criteria 40, the reward and recognition criteria 50, and the group training criteria 60, respectively. Each of the criteria steps 40, 50 and 60 are linked through to the performance assessment criteria 30 based, again, upon firstly the skill and knowledge base 1 and linkage of the relevant components of the previous step in the methodology 100. Each of these steps have components that are supportive of motivating and reinforcing the skills of the individual, and where applicable, the group. In other words, after a performance assessment has been completed for each employee, depending on the score (based upon a standard performance score) the employee is either recognized for their performance or given additional coaching. If the performance evaluation assessments show that there are a multiple number of people struggling with meeting job criteria then group training can be initiated. It is to be understood, of course, that there can be and/or are additional components.

For instance, utilizing again the example of the call center wherein the performance of the employee on the phone has been assessed and a score derived from such assessment, the score is determined based on a standard performance score scale to fall into potential categories of exceptional performance, average performance or below average performance. If it is determined that the call center employees rate of speech skill is less than desired, then in the individual coach and criteria step 40, the employee may be individually coached so as to improve his/her performance. Alternatively, if the call center employees' rate of speech skill assessment is high, then in the reward and recognition criteria step 50, such employee can be rewarded. If it has been determined that multiple call center employees are having difficulty with the rate of speech skill, then in group training criteria 60 a group training may be undertaken.

The seventh step in the responsive learning methodology 100 is the determining/identifying of the performance appraisal criteria 70. Performance appraisal criteria 70 is linked to each of the three previous criteria steps 40, 50 and 60 based upon, firstly, the skill and knowledge base 1 and, secondly, the relevant components of each of the three previous steps in the methodology 100. In performance appraisal criteria step 70, every six months to a year a performance appraisal is completed for each employee. The performance appraisal contains different areas to be rated based on the quality of performance delivered to the customer.

For instance, utilizing again the example of the call center, the annual performance appraisal will include as one of the areas upon which the employee is being rated the quality of the communication/rate of speech performance that the employee is delivering to the customer.

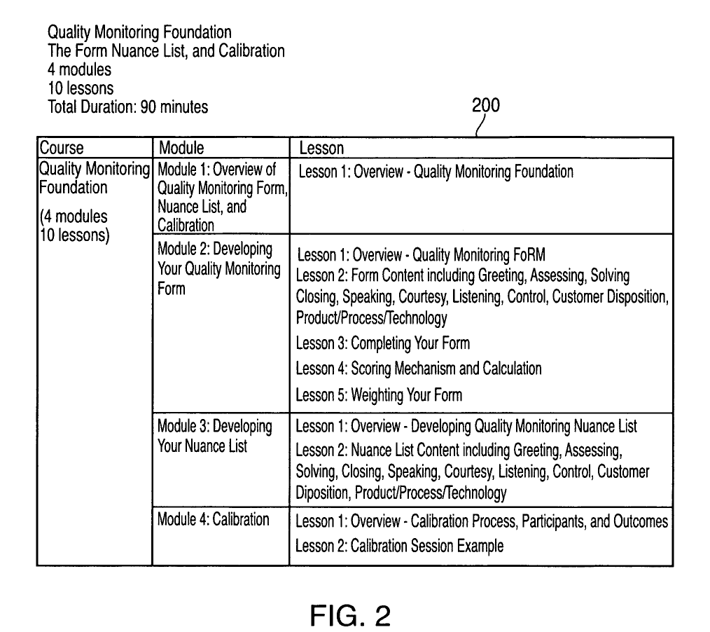

Referring now specifically to FIG. 2, a chart showing the preferred embodiment of the quality monitoring foundation course 200 is shown. The quality monitoring foundation course 200 consists of four modules comprising a total of 10 lessons. Module 1 consists of an overview of the quality monitoring form, nuance lists and calibration thereof. Module 2 consists of developing a quality monitoring form. Module 3 consists of developing a nuance list, and Module 4 consists of lessons relating to calibration of the raters to the forms and lists.

Each of these four modules has a number of lessons, as shown therein in the chart, and consist of a total time duration of approximately 90 minutes. With regard to the call center example, the lessons within each module can be linked to a call monitoring form. The call monitoring form is the basic tool that managers can use to identify gaps in the skills and knowledge of the call center agents.

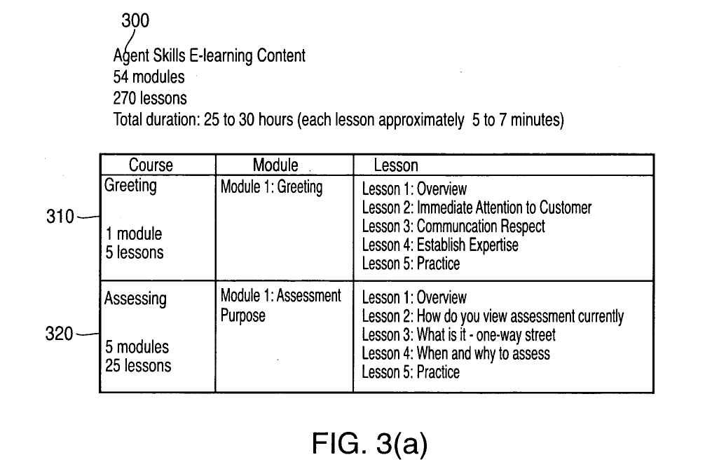

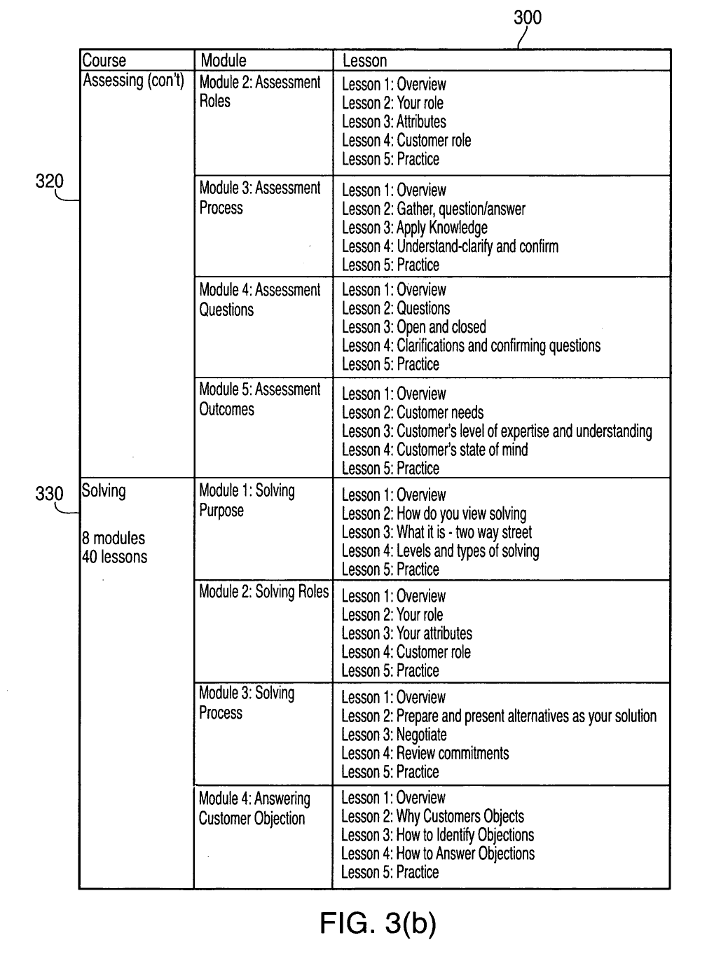

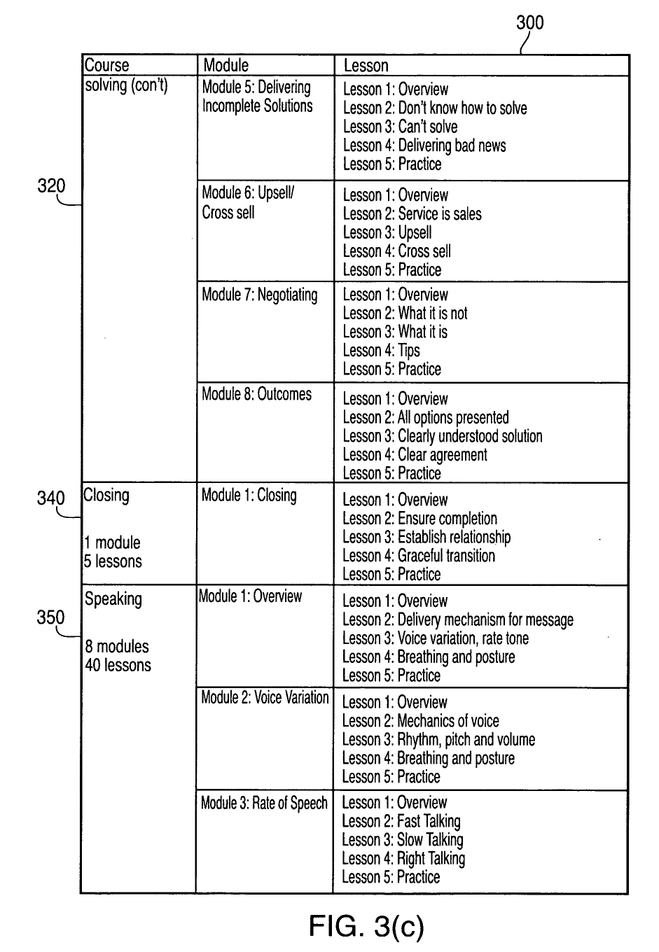

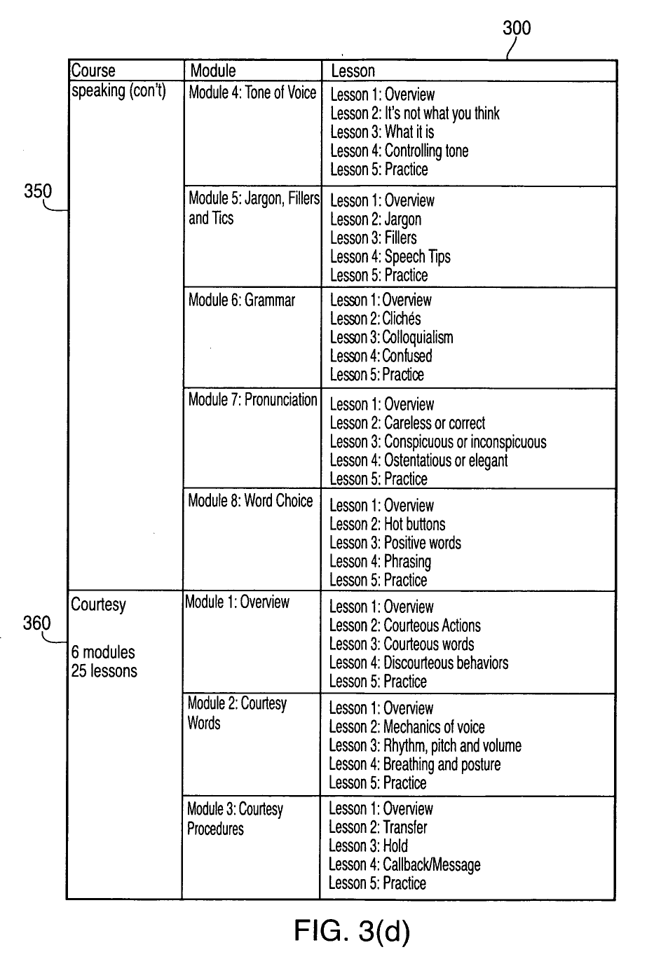

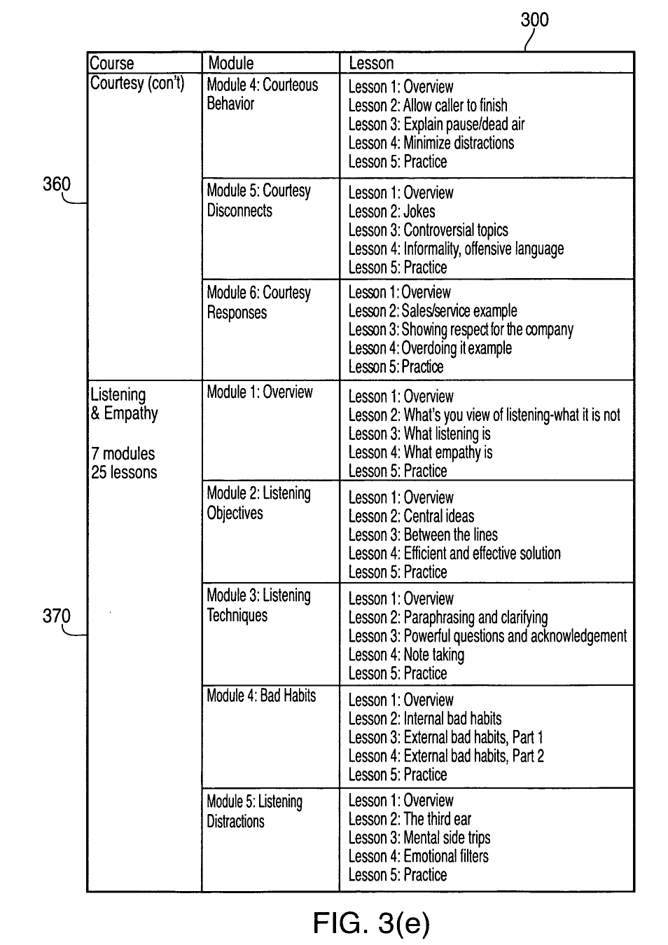

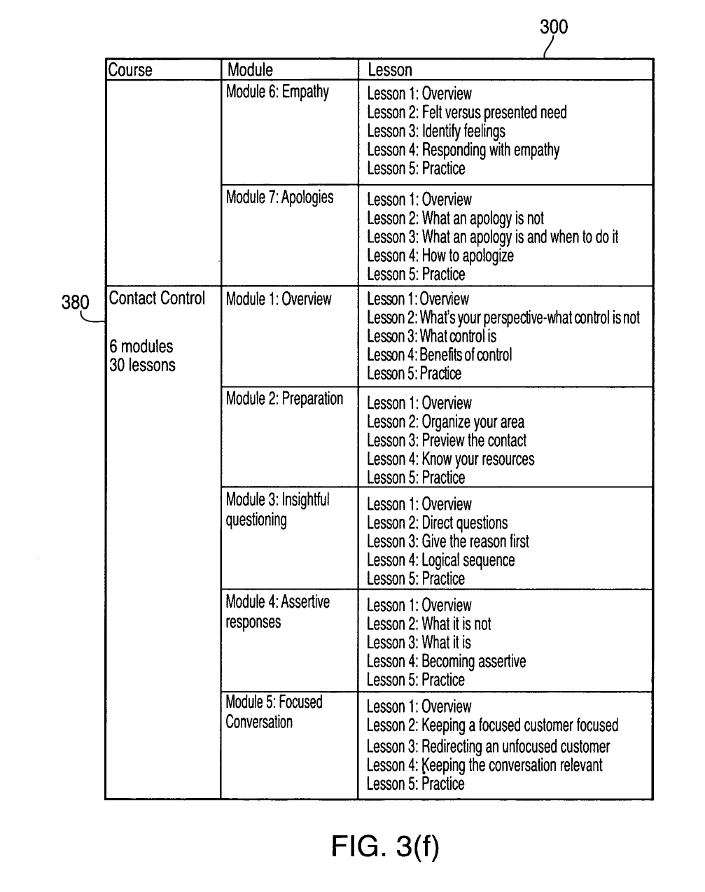

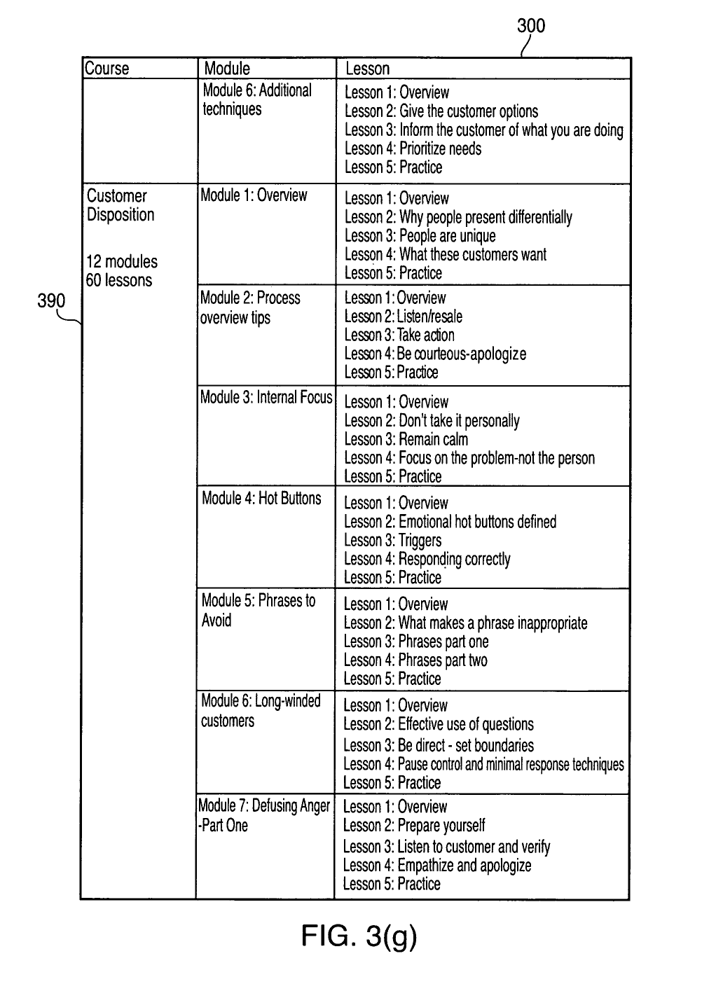

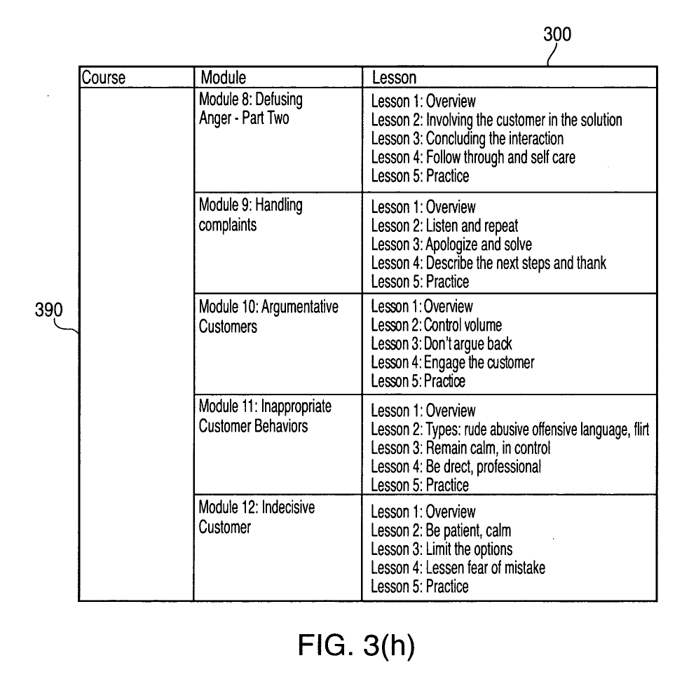

Referring now specifically to FIGS. 3(a) through 3(h), charts showing the preferred embodiment of the agent skills learning course 300 is shown. The agent skills learning content comprises 54 modules having a total of 270 lessons. The courses are broken down as: a greeting course 310, an assessing course 320, a solving course 330, a closing course 340, a speaking course 350, a courtesy course 360, a listening and empathy course 370, a contact control course 380, and a customer disposition course 390. As is shown in the content of the chart of the agent skills course 300, each course is modularized and has a particular unvarying number of modules, each module having a particular unvarying number of lessons for a community of users.

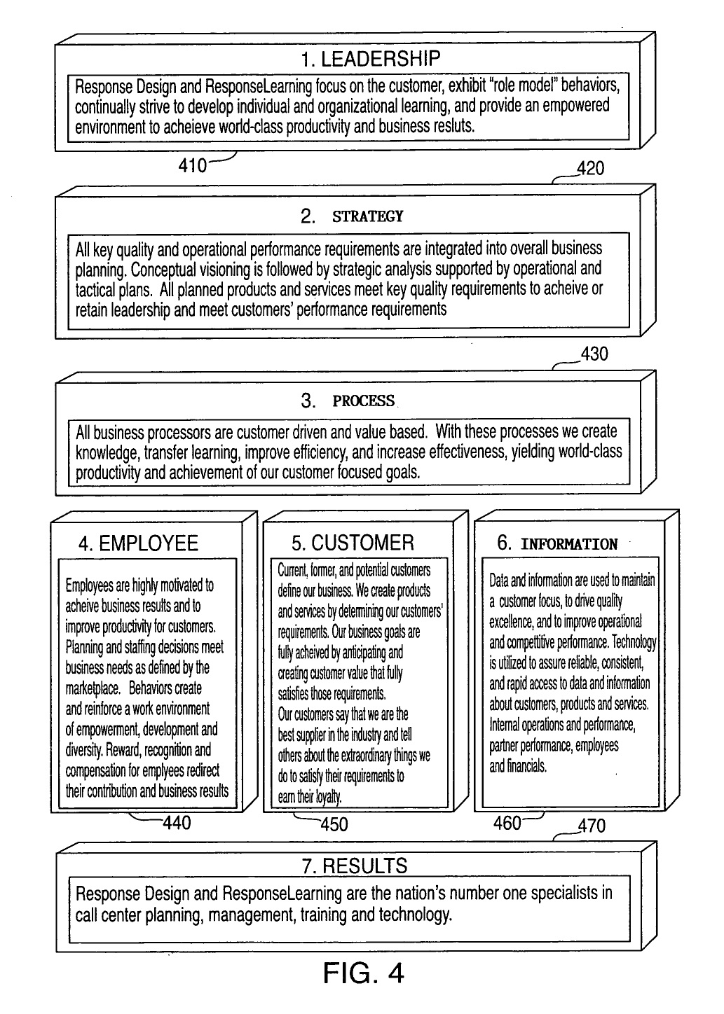

Referring now specifically to FIG. 4, a chart of a number of component pieces for a successful responsive learning program are shown. Implementation of the program utilizes these components as a basis to identify and develop the content for the various lessons.

The first component 410 allows for creation and implementation of leadership lessons that focus on the customer, exhibit role model behaviors that continually strive to develop individual and organizational learning, and provide an empowered environment to achieve world class productivity and business results.

The second component 420 allows for creation and implementation of lessons relating to strategy. Such strategy lessons relate to the key quality and operational performance requirement integrated into the overall business planning. Conceptual visioning is followed by strategic analysis supported by operational and tactical plans. All planned products and services meet key quality requirements to achieve or retain leadership and meet customers performance requirements.

The third component 430 involves process lessons wherein it is recognized that all business processes are customer driven and value based. With these processes knowledge, transfer of learning, improved efficiency and increased effectiveness, yield world class productivity and achievement of customer focused goals.

The first three components rely upon a base of the next three components, components 440, 450 and 460 respectively.

The fourth component 440 is the employee base that allows for creation and implementation of the lessons regarding leadership, strategy and processes in order to motivate the employees to achieve business results and to improve productivity for customers. Behaviors created by such activity reinforce a work environment of empowerment, development and diversity.

The fifth component 450 relates to the customer, that is, current, former and potential customers defined by the business.

The sixth component 460 relies upon information and data used to maintain a customer focus, to drive quality excellence and to improve operational and competitive performance.

The seventh, and final, component 470 is built upon the previous six components and results in success in planning, management, training and technology.

In the foregoing description, the method and apparatus of the present invention have been described with reference to specific examples. It is to be understood and expected that variations in the principles of the method and apparatus herein disclosed may be made by one skilled in the art and it is intended that such modifications, changes, and substitutions are to be included within the scope of the present invention as set forth in the appended claims. The specification and the drawings are accordingly to be regarded in an illustrative manner rather than in a restrictive sense.

What is claimed is:

1. A method for a responsive learning program to improve the quality and efficiency of an organization's personnel's set of skills and knowledge and thus allowing for the competent completion of the organization's personnel's job, the method comprising the steps of:
identify at least one recruiting/hiring criteria utilizing a skill and knowledge base;
identify at least one new hire initial training criteria utilizing the skill and knowledge base and by linking at least one component of the recruiting/hiring criteria;
identify at least one performance assessment criteria utilizing the skill and knowledge base and by linking at least one component of the new hire initial training criteria;
identify at least one individual coaching criteria utilizing the skill and knowledge base and by linking at least one component of the performance assessment criteria;
identify at least one reward and recognition criteria utilizing the skill and knowledge base and by linking at least one component of the performance assessment criteria;
identify at least one group training criteria utilizing the skill and knowledge base and by linking at least one component of the performance assessment criteria; and
identify at least one performance appraisal criteria utilizing the skill and knowledge base and by linking at least one component of at least one of the individual coaching criteria, the reward and recognition criteria and the group training criteria,
wherein the skill and knowledge base comprises a set of skills and knowledge that is required for the competent completion of the organization's personnel's job.

2. The method according to claim 1, wherein the at least one recruiting/hiring criteria comprises at least one component comprising at least one of:
a type of the personnel the organization needs for the job to be filled; and
a skill that the personnel needs to properly complete the job.

3. The method according to claim 1, wherein the at least one new hire initial training criteria comprises at least one component comprising at least one of:
an organization's products;
an organization's services; and
a reinforcement of the skills that the personnel was hired for.

4. The method according to claim 1, wherein the at least one performance assessment criteria comprises at least one component comprising at least one of:
a means to monitor for the skills upon which new hire training was conducted;
a means to monitor for the knowledge upon which new hire training was conducted; and
a quality monitoring form.

5. The method according to claim 4, wherein the quality monitoring form defines an expectation level for the at least one performance assessment criteria.

6. The method according to claim 1, wherein at least one of the at least one individual coaching criteria, the at least one reward and recognition criteria and the at least one group training criteria comprise at least one component comprising at least one of:
a motivation of the personnel; and
a reinforcement of the skills of the personnel.

7. The method according to claim 1, wherein at least one performance appraisal criteria comprises at least one component comprising at least one of:
a performance appraisal; and
a scheduled performance appraisal.

8. The method according to claim 1 embodied in a training program comprising of a series of courses that combine quality content with time compressed learning.

9. The method according to claim 8, wherein the training program is computer-based.

10. The method according to claim 8, wherein Webinars are conducted to support the training program.
